(19) United States
(12) Patent Application Publication
(10) Pub. No.: US 2007/0087127 A1
(43) Pub. Date: Apr. 19, 2007

(54) Manufacturing method of column and board articles

(76) Inventors: Leslie Nien, Changhua Hsien (TW); Hsiu Sheng Shih, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/329,144

(22) Filed: Jan. 11, 2006

(30) Foreign Application Priority Data
Oct. 14, 2005 (TW) 094135873

(51) Int. Cl. B32B 37/00

(52) U.S. Cl. 427/421.1; 156/254

(57) ABSTRACT

A manufacturing method of column and board articles comprises various types of recycled materials densely bonded onto the outer surfaces of a tough plate material of appropriate size and thickness to form a base board that, depending on the demand for the sizes and different shapes thereof, can be synchronically cut into a plurality of column articles and board articles, and a multi-colored and patterned decorative superficial layer can be coated to the periphery of the column or board article thereon. Therefore, in addition to making use of the recycled materials for the benefit of environmental protection, the column and board articles are respectively supported at the core by the tough plate material and reinforced in their durability and tenacity to achieve widespread application to versatile furniture and building materials thereby.

### BACKGROUND OF THE INVENTION

The present invention is related to a manufacturing method of column and board articles, comprising a tough plate material and recycled materials densely bonded to one another to form a base board that can be synchronically cut into a plurality of column articles and board articles wherein the column and board articles are respectively reinforced at the core by the tough plate material having a central supporting effect to prevent the risk of deformation when affected by outer force, efficiently enhancing the durability and tenacity of the column and board articles and facilitating widespread application thereof to versatile furniture and building materials thereby.

Please refer to FIG. 1 showing a cross sectional view of a conventional column or board article. A conventional column or board article has an outer frame made up of a paper tube 10 into which recycled wood pieces 11 and sawdust 12 are filled to form the strengthening and filling material at the core of the paper tube 10 therein. A cap 13 is applied to seal up the bottom edge of the column or board article so as to retain the filling material at the core of the paper tube 10 therein, and a superficial coating material 14 is wrapped around or bonded to the periphery of the column or board articles to conceal the paper tube 10 therein for protection thereby.

There are some drawbacks to such conventional column or board article. First, the paper tube 10 served as an outer frame of the column or board article must be separately processed according to the sizes and shapes of the column or board article before the wood pieces 11 and the sawdust 12 are applied and filled therein, and the cap 13 must be sealed up to the paper tube 10 to prevent the wood pieces 11 or sawdust 13 from falling outwards at the other end of the paper tube 10 during the filling-up process thereof. Thus, the conventional column or board article composed of multiple assembling parts is complicated in the manufacturing process, which may uneconomically increase the manufacturing steps as well as boost the cost of production. Second, in the manufacturing process, each paper tube 10 of the column or board article must have the cap 13 mounted to the bottom edge before the wood pieces 11 or sawdust 12 is filled therein and the coating material 14 is bonded thereon, which is not only troublesome but also time-consuming in the whole process thereof. Third, after the wood pieces 11 or sawdust 12 is filled into the paper tube 10 therein, force cannot be exerted to press tight the accommodated wood pieces 11 or sawdust 12 due to the restriction of the paper tube 10 thereof, which renders the column or board article a rather weak support in application thereof.

Furthermore, the MDF artificial laminate, or laminated veneer found on the market usually has a core layer composed of wood pieces, debris, or sawdust mixed with glue and thermally processed into form, which makes the core layer lack of support in construction. Thus, the conventional MDF or laminated veneer, etc. cannot be individually applied to some supporting construction (like supporting legs or columns, etc), and can only be used as panels in a limited application.

Still furthermore, another conventional board article is characterized by a core layer made up of block-like panels lap joined or finger joined together wherein the block-like panels are made up of solid wood chunks and recycled materials cannot be accurately used to the board article thereof, which not only reduce the benefit of environmental protection, but also boost the cost of material thereof.

### SUMMARY OF THE PRESENT INVENTION

It is, therefore, the primary purpose of the present invention to provide a manufacturing method of column and board articles, comprising a tough plate material and recycled materials densely bonded to one another to form a base board that can be synchronically cut into a plurality of column articles or board articles wherein the column and board articles are respectively strengthened at the core by the tough plate material having a central supporting effect to prevent the risk of deformation when affected by outer force and, thus, reinforce the durability and tenacity of the column and board articles thereby, facilitating widespread application of the column and board articles to versatile furniture and building materials thereby.

It is, therefore, the second purpose of the present invention to provide a manufacturing method of column and board articles wherein the recycled materials are directly bonded in dense engagement with the tough plate material to form a base board of appropriate size and thickness for further cutting into column articles and board articles of various configurations so that the paper tube and the cap of the above-mentioned prior art can be economically omitted, efficiently making use of the recycled materials for the benefit of environmental protection as well as reducing the cost of materials thereby.

It is, therefore, the third purpose of the present invention to provide a manufacturing method of column and board articles wherein the recycled materials are densely bonded onto the tough plate material to form a base board of appropriate size and thickness that can be further cut into column articles and board articles of various configurations without the filling process of the paper tube and the assembly of the cap of the prior art, economically providing a simplified and speedier manufacturing process to reduce the cost of materials and production and make the present invention more competitive on the market thereof.

### BRIEF DESCRIPTION OF THE DRAWINGS

FIG. 1 is an assembled cross sectional view of a conventional column or board article.

FIG. 2 is a manufacturing flow chart of the present invention.

FIG. 3 is a perspective view of the present invention molded into a cylindrical-shaped column article.

FIG. 4 is a perspective view of the present invention molded into a polygonal-shaped column article.

FIG. 5 is a perspective view of the present invention molded into a flower-shaped column article.

FIG. 6 is a perspective view of the present invention molded into a rectangular-shaped column article.

FIG. 7 is a perspective view of the present invention molded into a rectangular sheet-like board article.

FIG. 8 is a diagram showing floor panels made up of the board articles of FIG. 7 in application.

FIG. 9 is a diagram showing the column article of the present invention with spirally engraved pattern carved thereon.

FIG. 10 is a flat view of another embodiment of the present invention.

FIG. 11 is a flat view of still another embodiment of the present invention.

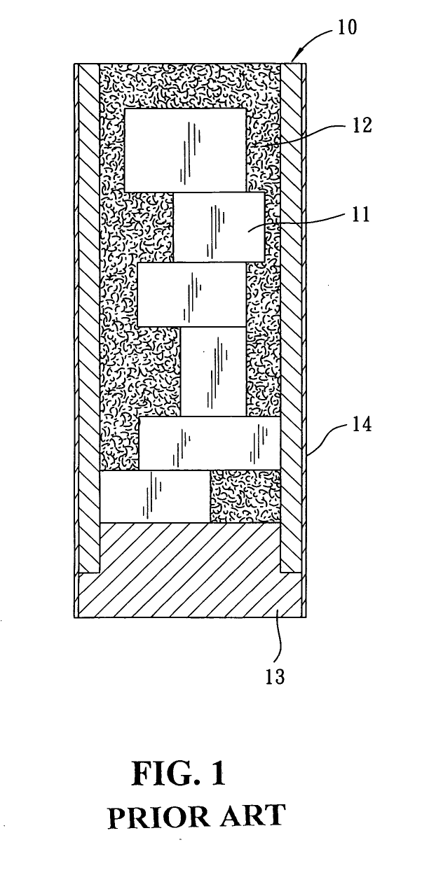

### DETAILED DESCRIPTION OF THE PREFERRED EMBODIMENTS

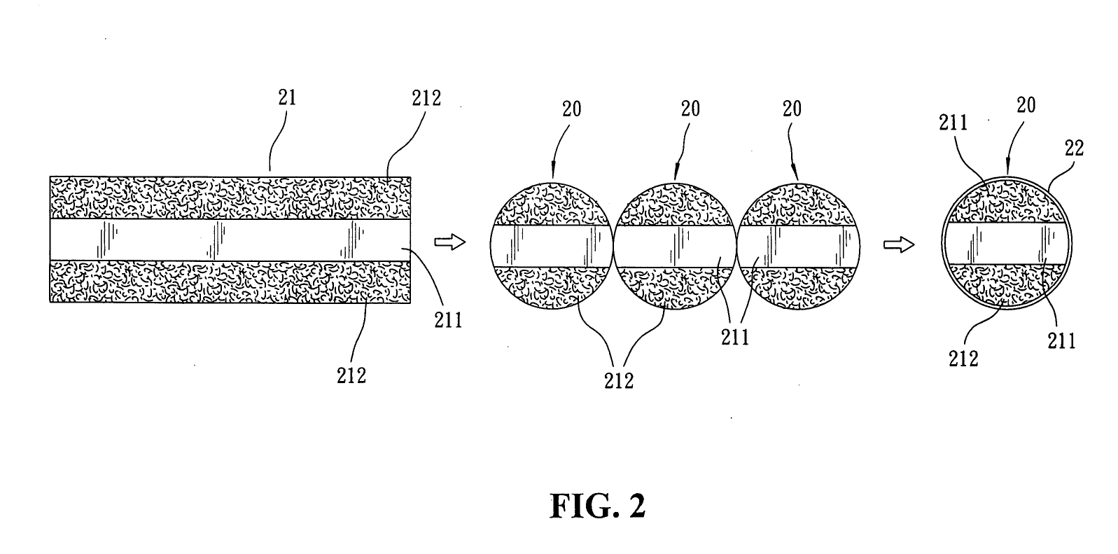

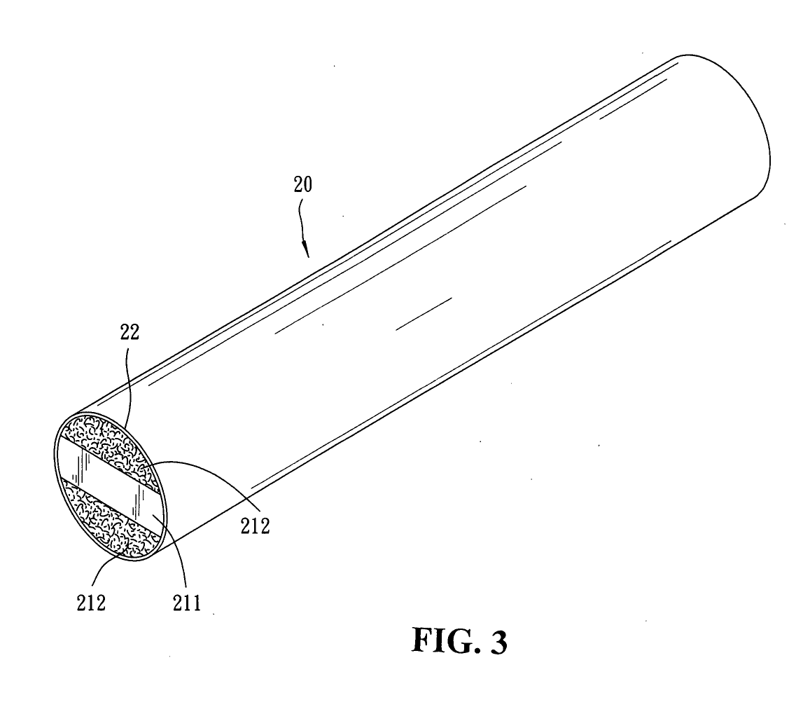

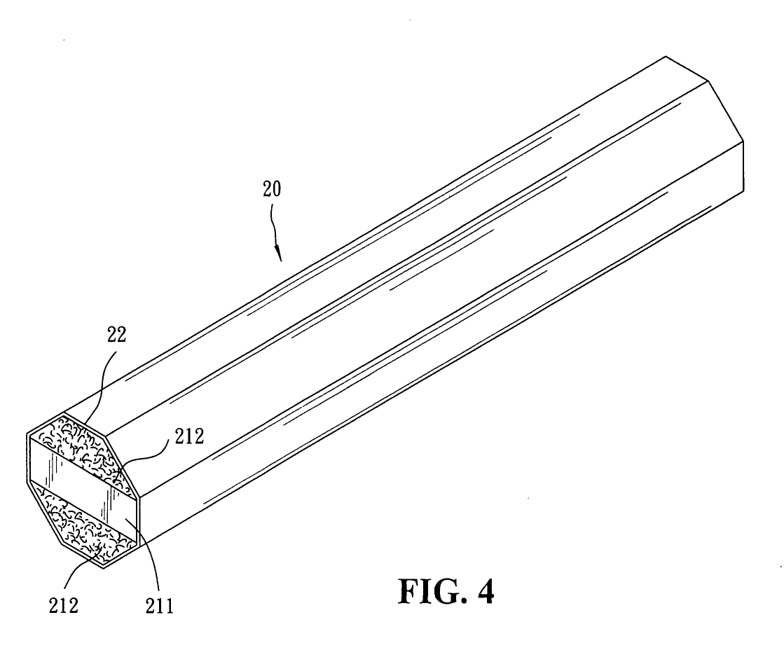

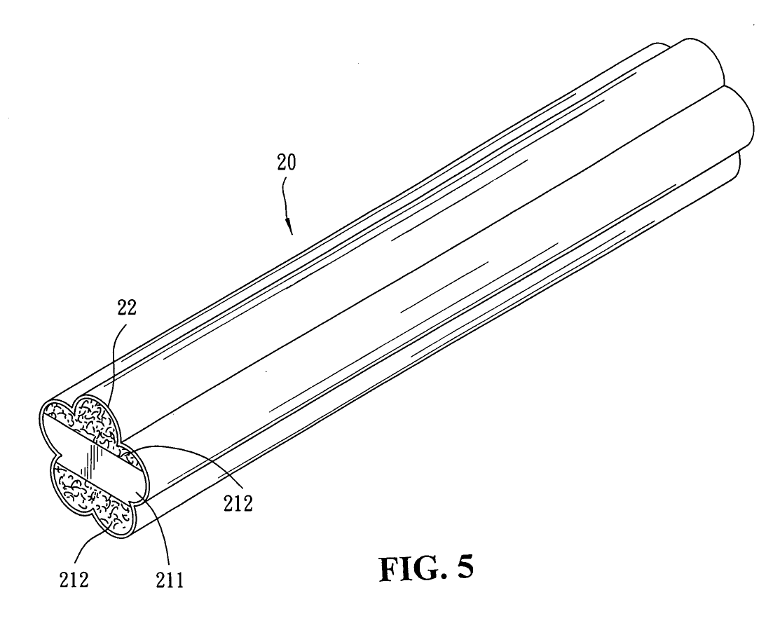

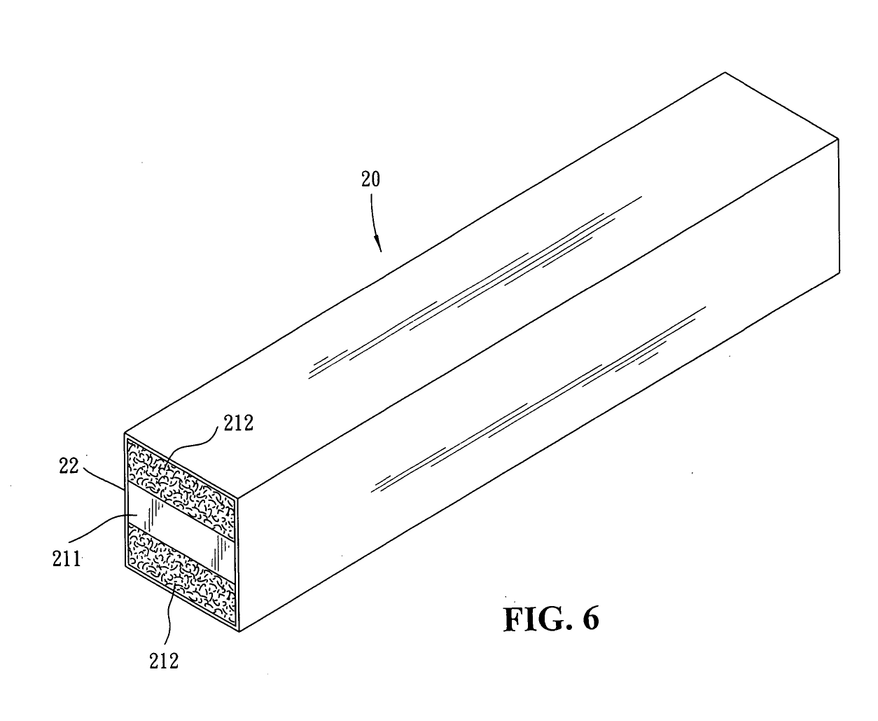

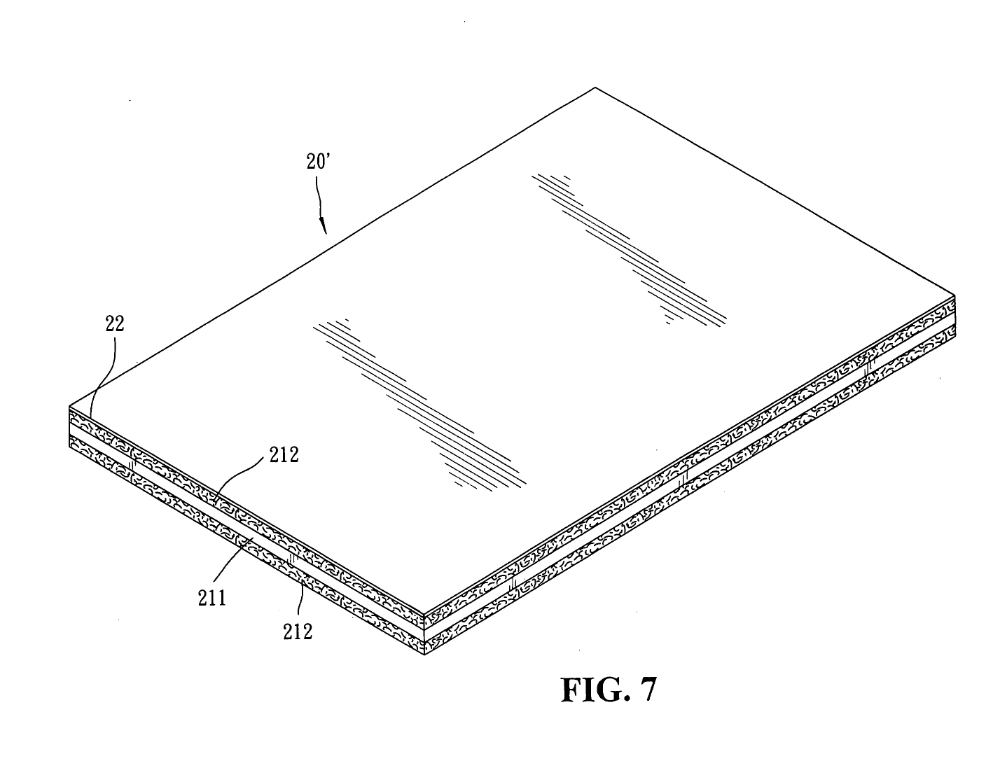

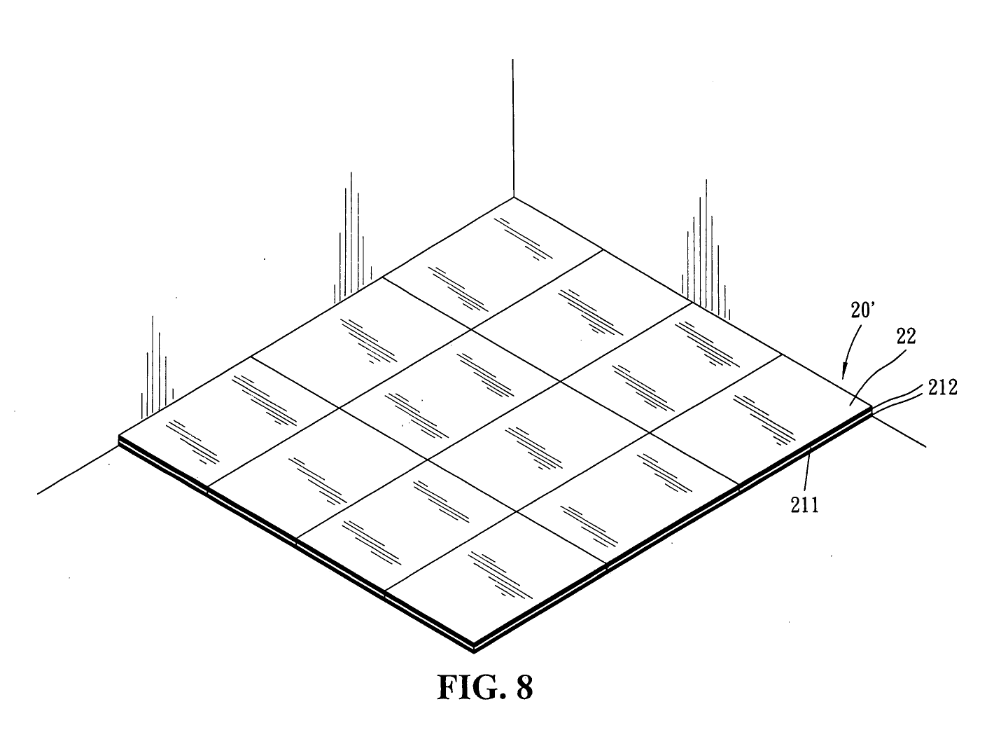

Please refer to FIG. 2 showing a manufacturing flow chart of the present invention. The present invention is related to a manufacturing method of column and board articles, comprising a supporting tough plate material 211 of an appropriate size and thickness, and various types of recycled materials 212 like wood pieces or sawdust to be evenly coated at the outer surfaces of the tough plate material 211 thereon wherein the recycled materials 212 are densely bonded (either by laminated or pressed binding engagement, etc.) to the outer surfaces of the tough plate material 211 to form a base board 21 thereby. And depending on the demand for the sizes and different shapes thereof, the base board 21 molded by the dense combination of the tough plate material 211 and the recycled materials 212 can be synchronically cut into multiple column articles 20 of different configurations such as a cylindrical shape as shown in FIG. 3, a polygonal shape as shown in FIG. 4, a flower-like shape as shown in FIG. 5 or a rectangular shape as shown in FIG. 6, as well as cut into rectangular sheet-like board articles 20′ as shown in FIG. 7. The column articles 20 and the board articles 20′ can efficiently make use of recycled materials to enhance the benefit of environmental protection. Meanwhile, the tough plate material 211 can provide supporting effect at the core of each column and board article 20, 20′ to prevent the deformation of the column and board article 20, 20′ affected by force exerted thereon, efficiently reinforcing the durability and tenacity of the column and board articles 20, 20′ thereby. And the recycled materials 212 are substantially bonded tight to the outer surfaces of the tough plate material 211 to enhance the density of the column and board article 20, 20′. Furthermore, the periphery of the column and board article 20, 20′ thereof can also have a multi-colored and patterned decorative superficial layer 22 (such as real wood veneer, wood-grain veneer and paper veneer, etc.) to be laminated thereon or coated thereon via spraying and lacquering operation, permitting the surfaces of the column and board article 20, 20′ to equip with protection and damp-resistant effects thereby. Therefore, the column and board articles 20, 20′ of the present invention are molded in a simplified and speedier manufacturing method without the filling process of the paper tube and the assembly of the cap as disclosed in the above-mentioned conventional column and board articles, economically reducing the cost of materials and making the present invention more competitive on the market. Besides, via the central supporting effect of the tough plate material 211 formed at the core thereof, the column and board articles 20, 20′ can be widely applied to versatile furniture and building materials. For example, the column articles 20 can serve as legs or blind rods, etc. and the board articles 20′ can be applied to floor panels or table panels as shown in FIG. 8, achieving a flexibility in application thereof.

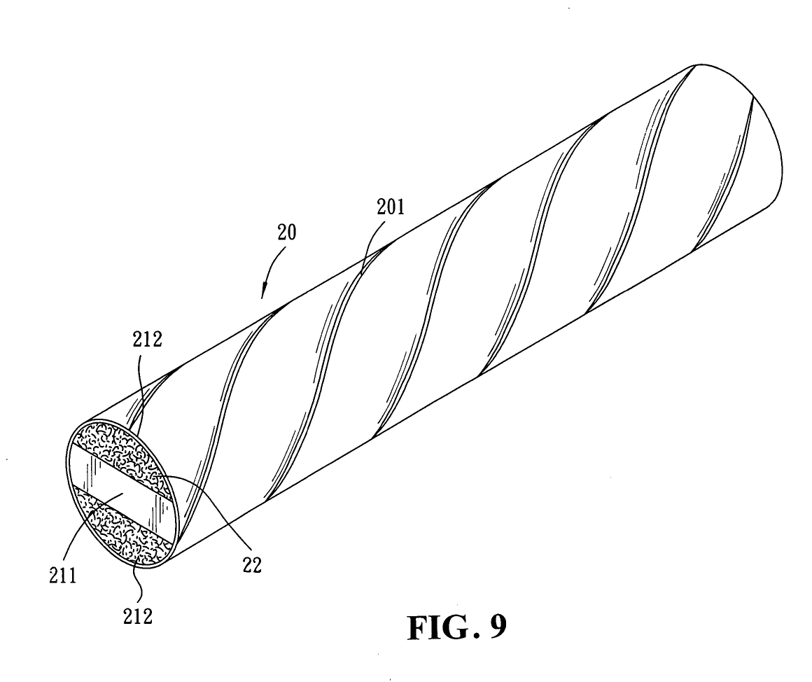

Moreover, the circumferential surface of the column article 20 can also have various engraved pattern 201 like spiral figures carved thereon before the decorative superficial layer 22 is coated thereon via spraying or lacquering operation, permitting the engraved pattern 201 to distinctively reveal on the surface of the column article 20 as shown in FIG. 9.

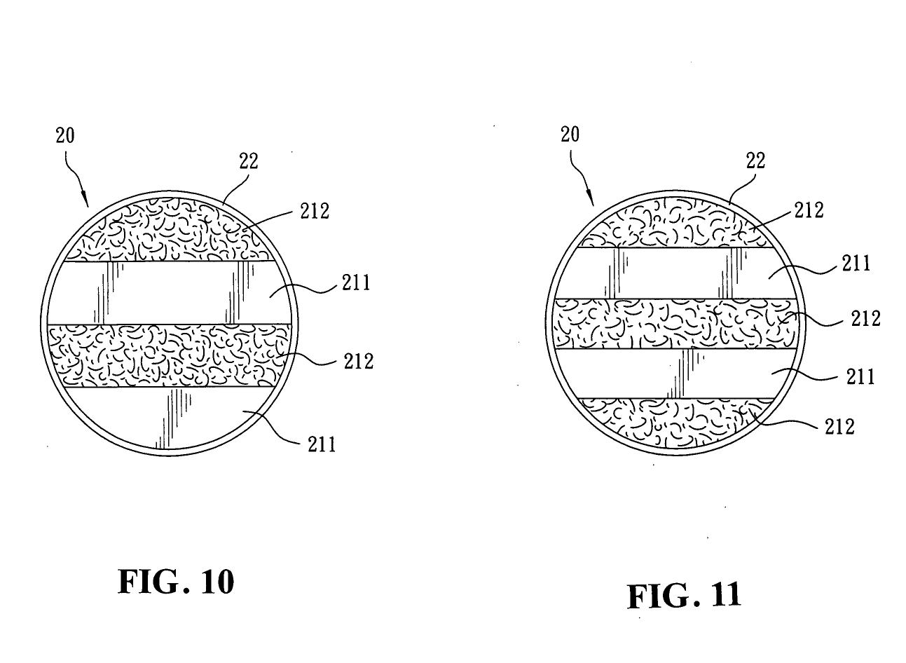

Please refer to FIG. 10 showing a flat view of another embodiment of the present invention (accompanied by FIG. 11). The recycled materials 212 and the tough plate material 211 of the column and board articles 20, 20′ thereof can also be alternatively arranged in stacks and densely bonded tight and close to one another in construction thereof.

What is claimed is:

1. A manufacturing method of column and board articles, comprising a supporting tough plate material of appropriate size and thickness, and recycled materials evenly coated at the outer surfaces of the tough plate material thereon wherein the recycled materials are densely bonded to the outer surfaces of the tough plate material to form a base board that, depending on the demand for the sizes and different shapes thereof, can be synchronically cut into a plurality of column articles and board articles; therefore, in addition to making use of recycled materials for environmental protection, the column and board articles are respectively reinforced at the core by the tough plate material that, having a central supporting effect, can prevent the deformation of the column and board articles affected by force exerted thereon, increasing the durability and tenacity of the column and board articles thereby; moreover, the recycled materials are substantially bonded tight to the outer surfaces of the tough plate material to enhance the density of the column and board articles, and a multi-colored and patterned decorative superficial layer can also be coated at the periphery of the column and board articles thereon.

2. The manufacturing method of column and board articles as claimed in claim 1 wherein the circumferential surface of the column article thereof can also have versatile engraved pattern like spiral figures carved thereon before the decorative superficial layer is coated thereon via spraying or lacquering operation, permitting the engraved pattern to distinctively reveal on the surface of the column article thereby.

3. The manufacturing method of column and board articles as claimed in claim 1 wherein the recycled materials can be composed of wood pieces or sawdust, etc.

4. The manufacturing method of column and board articles as claimed in claim 1 wherein the column article thereof can be molded in the form of a cylindrical-shaped configuration.

5. The manufacturing method of column and board articles as claimed in claim 1 wherein the column article thereof can be molded in the form of a polygonal-shaped configuration.

6. The manufacturing method of column and board articles as claimed in claim 1 wherein the column article thereof can be molded in the form of a flower-shaped configuration.

7. The manufacturing method of column and board articles as claimed in claim 1 wherein the column article thereof can be molded in the form of a rectangular-shaped configuration.

8. The manufacturing method of column and board articles as claimed in claim 1 wherein the board article thereof can be molded in the form of a rectangular sheet-like configuration.

9. The manufacturing method of column and board articles as claimed in claim 1 wherein the decorative superficial layer thereof can be composed of real wood veneer bonded to the surfaces of the column or board article thereon.

10. The manufacturing method of column and board articles as claimed in claim 1 wherein the decorative superficial layer thereof can be composed of wood-grain veneer bonded to the surfaces of the column or board article thereon.

11. The manufacturing method of column and board articles as claimed in claim 1 wherein the decorative superficial layer thereof can be composed of paper veneer bonded to the surfaces of the column or board article thereon.

12. The manufacturing method of column and board articles as claimed in claim 1 wherein the decorative superficial layer thereof can be coated onto the surfaces of the column or board article by way of spraying operation.

13. The manufacturing method of column and board articles as claimed in claim 1 wherein the decorative superficial layer thereof can also be coated onto the surfaces of the column or board article by way of lacquering operation.

14. The manufacturing method of column and board articles as claimed in claim 1 wherein the recycled materials and the tough plate material of the column and board articles thereof can also be alternatively arranged in stacks and densely bonded to one another in construction thereof.
